(19) United States
(12) Patent Application Publication
(10) Pub. No.: US 2011/0232985 A1
(43) Pub. Date: Sep. 29, 2011

(54) POWER DRIVE ASSISTANT SYSTEM FOR BICYCLE

(76) Inventor: CHIH HSING LEE, TAIPEI COUNTY (TW)

(21) Appl. No.: 12/732,458

(22) Filed: Mar. 26, 2010

(51) Int. Cl. B60K 1/00

(52) U.S. Cl. 180/297

(57) ABSTRACT

A power drive assistant system includes a wheel mover detachably fastened to the seat tube of a bicycle and holding an external rotor motor in friction contact with the rear wheel of the bicycle and controllable to rotate the rear wheel of the bicycle by means of a friction force, a rechargeable battery pack mounted on the seat pillar of the saddle of the bicycle to provide the external rotor motor of the wheel mover with the necessary working voltage, and a speed controller mounted on the handlebars of the bicycle for regulating the speed of the external rotor motor.

### BACKGROUND OF THE INVENTION

1. Field of the Invention

The present invention relates to bicycles and more particularly, to a power drive assistant system for easy installation in a bicycle to rotate the rear wheel by means of a friction force subject to the operation of a battery-operated motor rotor.

2. Description of the Related Art

Following the growing awareness of environmental protection concept and the growing of energy crisis, bicycle has been intensively used by people as one's personal transportable vehicle for the purpose of exercise. Using a bicycle as one's personal transportable vehicle instead of a motorcycle or car effectively achieves energy saving and carbon reduction. Many bicycles are made foldable for carrying by a user who is taking a mass transportable vehicle. There are bicycles equipped with a power drive assistant system to assist the user reduce physical load.

However conventional power drive assistant systems for bicycle are still not satisfactory in function and have drawbacks as follows:

1. Conventional power drive assistant systems for bicycle are not DIY (do-it-yourself) designs, not practical for installation by users.

2. During operation of the motor of a conventional power drive assistant system in a bicycle, the pedals of the bicycle are rotated, causing danger.

3. During rotation of the gears and chain of a conventional power drive assistant system in a bicycle, a high level of noise will be produced.

Therefore, it is desirable to provide a power drive assistant system for bicycle that eliminates the aforesaid drawbacks.

### SUMMARY OF THE INVENTION

The present invention has been accomplished under the circumstances in view. It is one object of the present invention to provide a power drive assistant system for bicycle, which has light weight, small size and DIY design characteristics. It is another object of the present invention to provide a power drive assistant system for bicycle, which is practical for installation in any of a variety of bicycles by a user conveniently. It is still another object of the present invention to provide a power drive assistant system for bicycle, which combines a motor and a battery to assist the bicycle for short-distance and local-area application, satisfying the requirements for energy saving and carbon reduction.

To achieve these and other objects of the present invention, a power drive assistant system comprises a wheel mover mounted on the seat tube of a bicycle, a rechargeable battery pack mounted on the bicycle and adapted for providing the necessary working voltage to the wheel mover, and a speed controller for controlling the speed of the wheel mover. The wheel mover comprises a motor holder holding a motor, for example, external rotor motor that can be moved into friction contact with the rear wheel of the bicycle and then controlled to rotate the rear wheel of the bicycle, a rotary shaft movably coupled to the motor holder, and a clamp pivotally connected to the rotary shaft for fastening the rotary shaft to the seat tube of the bicycle.

Further, a clutch structure is coupled between the rotary shaft and the clamp for allowing elevational adjustment of the rotary shaft relative to the clamp to move the external rotor motor into friction engagement with the rear wheel of the bicycle or away from the rear wheel of the bicycle.

### BRIEF DESCRIPTION OF THE DRAWINGS

FIG. 1 illustrates a power drive assistant system installed in a bicycle according to the present invention.

FIG. 2 is an enlarged view of a part of FIG. 1.

FIG. 3 is an elevational view of the wheel mover of the power drive assistant system according to the present invention.

FIG. 4 is a top view of FIG. 3.

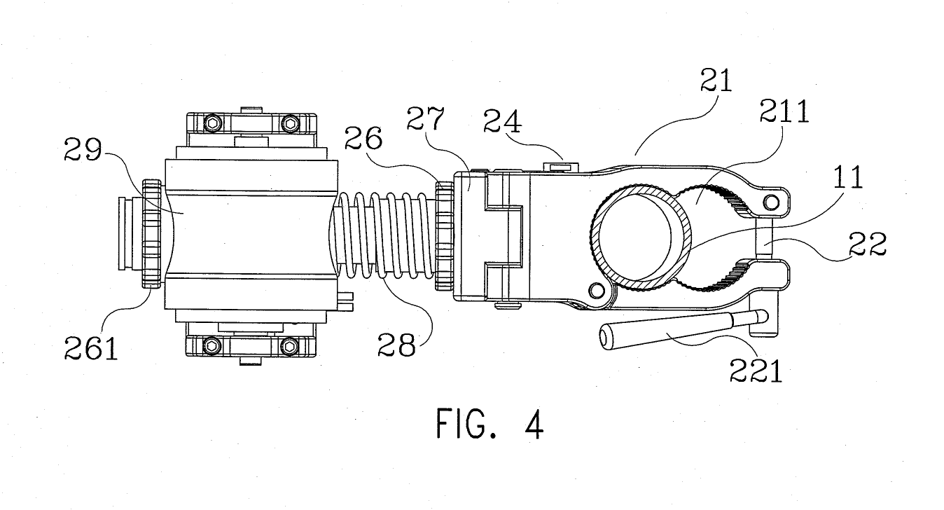

FIG. 5 is a side view of FIG. 3.

FIG. 6 corresponds to FIG. 5, showing the arrangement of the clutch structure between the rotary shaft and the clamp.

FIG. 7 is an enlarged view of a part of FIG. 6.

FIG. 8A illustrates an operation status of the clutch structure of the power drive assistant system according to the present invention.

FIG. 8B illustrates another operation status of the clutch structure of the power drive assistant system according to the present invention.

FIG. 9A illustrates the rotary shaft of the wheel mover in the high position according to the present invention.

FIG. 9B illustrates the rotary shaft of the wheel mover in the low position according to the present invention.

### DETAILED DESCRIPTION OF THE PREFERRED EMBODIMENT

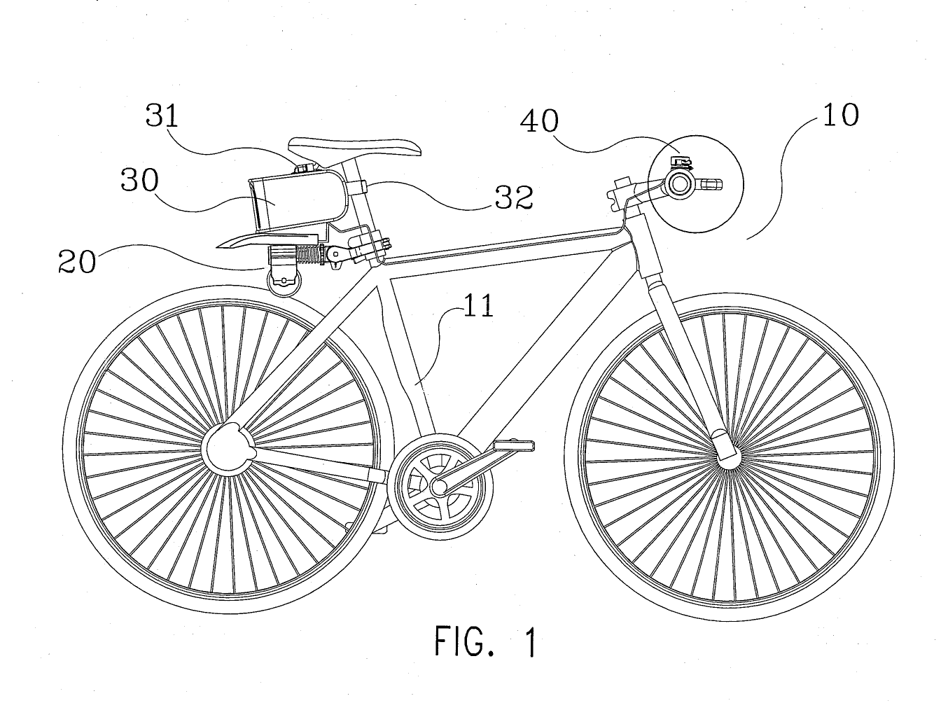

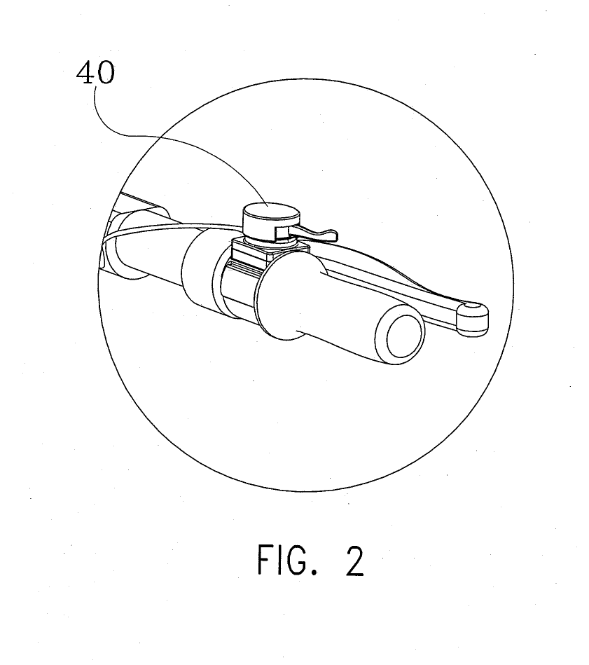

Referring to FIGS. 1 and 2, a power drive assistant system used in a bicycle 10 in accordance with the present invention is shown comprising a wheel mover 20, a rechargeable battery pack 30 and a speed controller 40.

The wheel mover 20 is affixed to the seat tube 11 of the bicycle 10. The rechargeable battery pack 30 is affixed to the seat pillar of the saddle of the bicycle 10 by means of a clamp 31 and fastening belt 32. Further, the speed controller 40 is installed in the handlebar of the bicycle 10.

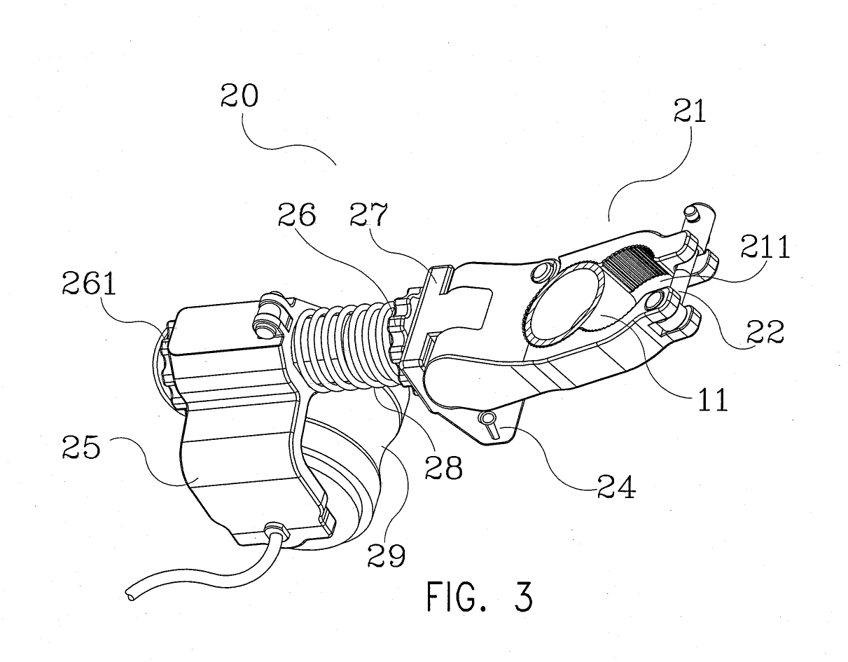

Referring to FIGS. 3˜5, the wheel mover 20 comprises a rotary shaft 27, a motor holder 25, and a clamp 21.

The clamp 21 is formed of a fixed jaw and a movable jaw and pivotally connected to one end of the rotary shaft 27, defining a clamping mouth 211 between the fixed jaw and the movable jaw for receiving the seat tube 11 of the bicycle 10. A locking pin 22 is pivotally connected to the free end of the fixed jaw of the clamp 21. An operating handle 221 is pivotally connected to the free end of the locking pin 22 and operable to secure the free end of the locking pin 22 to the free end of the movable jaw of the clamp 21 and to further lock the clamp 21 to the seat tube 11 of the bicycle 10.

The rotary shaft 27 is coupled to the motor holder 25. A spring member 28 is sleeved onto the rotary shaft 27 and stopped against the front side of the motor holder 25. An adjustment nut 26 threaded onto the rotary shaft 27 and stopped against one end of the spring member 28 opposite to the motor holder 25 and rotatable relative to the rotary shaft 27 to adjust the spring force of the spring member 28. A lock nut 261 is mounted on the rear end of the rotary shaft 27 at the rear side of the motor holder 25 and rotatable to lock the rotary shaft 27 to the motor holder 25. Further, a motor 29 is mounted in the motor holder 25 at the bottom side and electrically connected to the rechargeable battery pack 30. Further, the motor 29 according to the present preferred embodiment is an external rotor motor for rotating the real wheel of the bicycle 10 by means of a friction force.

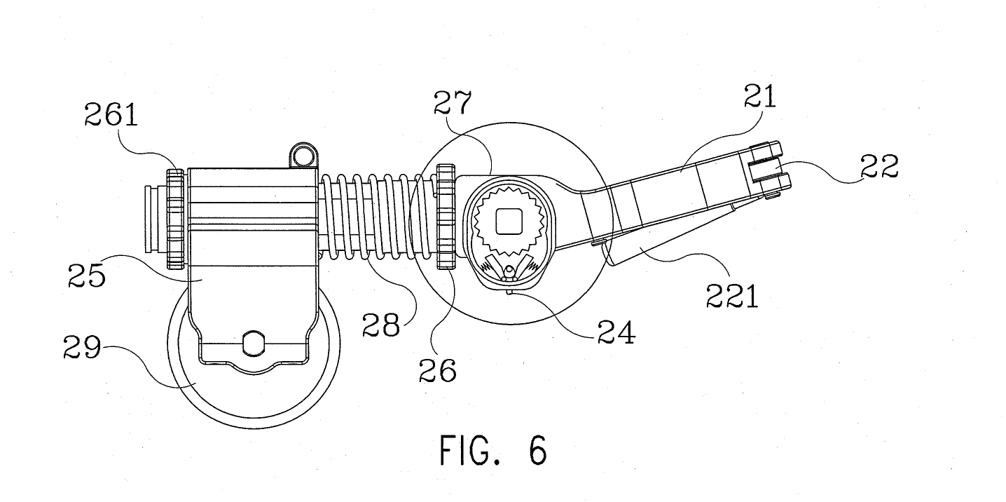

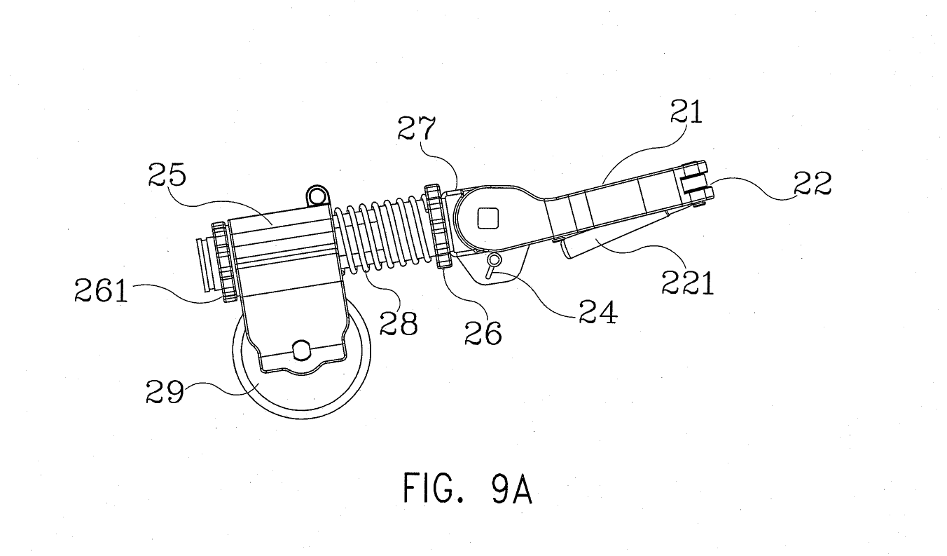

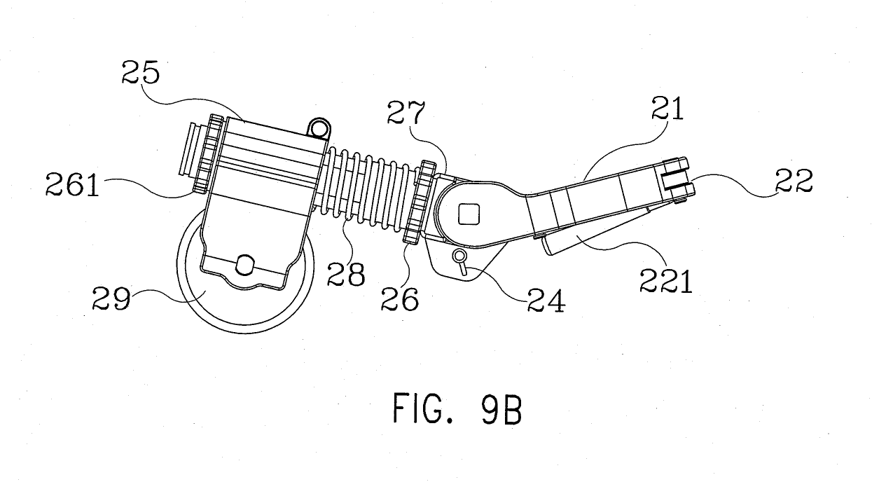

Referring to FIGS. 6, 7, 8, 9A and 9B, a clutch structure is provided between the clamp 21 and the rotary shaft 27 for allowing adjustment of the elevation of the rotary shaft 27 relative to the clamp 21 to move the motor 29 toward or away from the rear wheel of the bicycle 10 between a low position (see FIG. 9A) and a high position (see FIG. 9B).

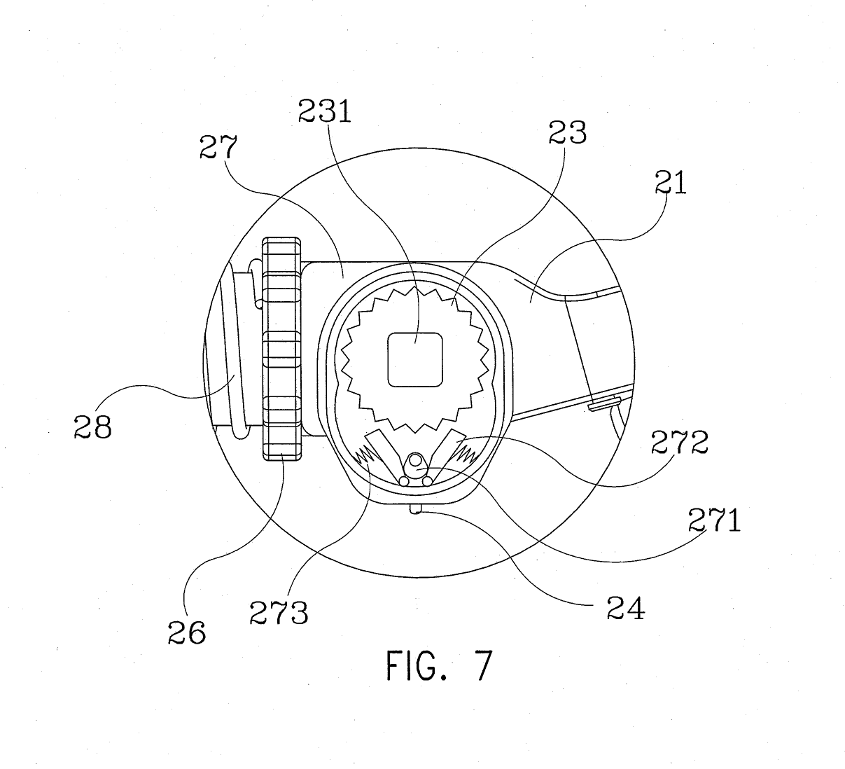

The clutch structure comprises a rectangular bar 231 transversely disposed at the rear side of the clamp 21, a gear 23 fixedly mounted on the rectangular bar 231, two spring members 273 mounted in the front side of the rotary shaft 27 adjacent to the gear 23, two pawls 272 respectively supported on the spring members 273, a clutch lever 24 pivotally connected to the front side of the rotary shaft 27, and a cam 271 fixedly mounted on one end of the lever 24 and stopped between the pawls 272 (see FIG. 7).

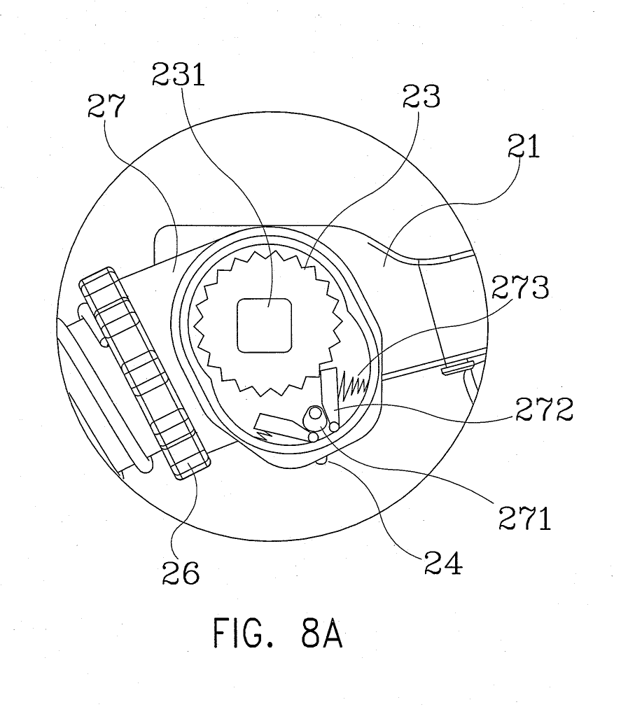

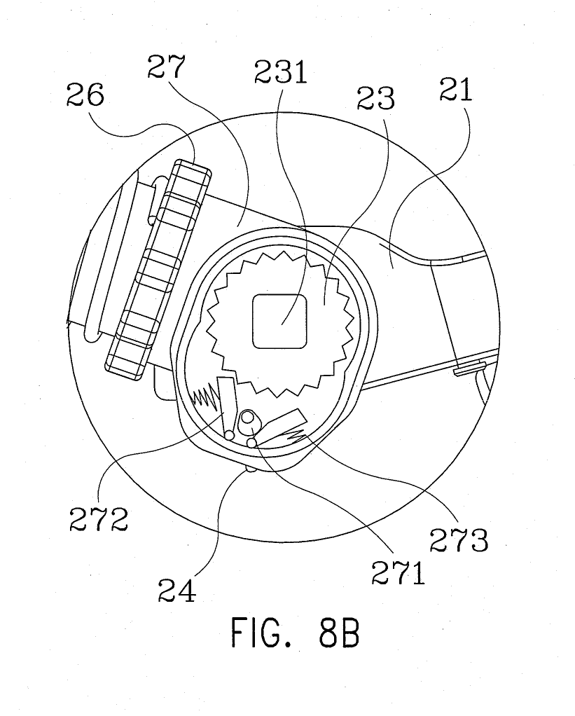

When wishing to lower the rotary shaft 27 and the motor holder 25 with the motor 29 to the low position (see FIG. 8A and FIG. 9A), move the clutch lever 24 to the left side to force the cam 271 against the left-sided pawl 272 and to further move the left-sided pawl 272 away from the gear 23, and then lower the rotary shaft 27 and the motor holder 25 relative to the clamp 21, forcing the motor 29 into contact with the rear wheel of the bicycle 10. On the contrary, when wishing to lift the rotary shaft 27 and the motor holder 25 with the motor 29 to the high position (see FIG. 8B and FIG. 9B), move the clutch lever 24 to the right side to force the cam 271 against the right-sided pawl 272 and to further move the right-sided pawl 272 away from the gear 23, and then lift the rotary shaft 27 and the motor holder 25 relative to the clamp 21, disengaging the motor 29 from the rear wheel of the bicycle 10. When moving one pawl 272 away from the gear 23, a clicking sound will be produced.

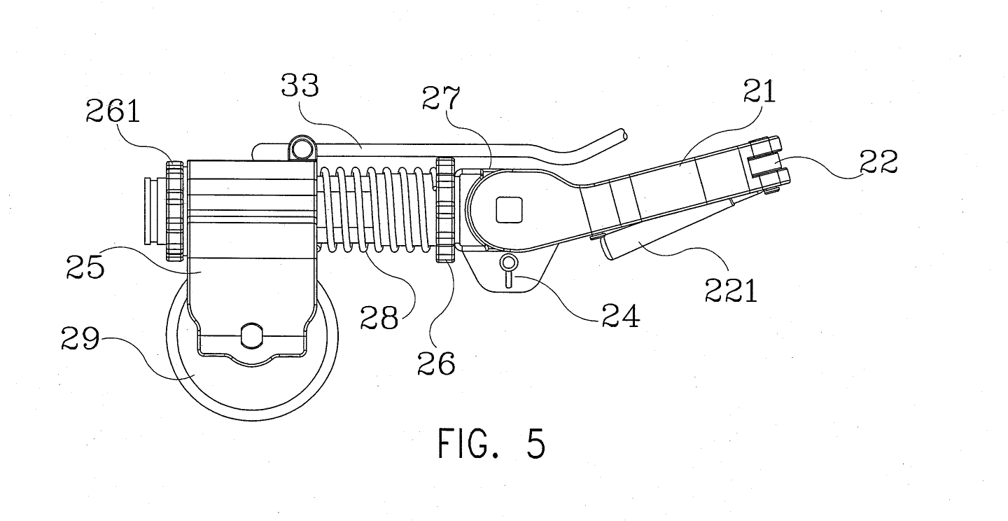

Further, the motor 29 is electrically connected to the rechargeable battery pack 30 by a power cord 33 (see FIG. 5). Thus, the rechargeable battery pack 30 provides the motor 29 with the necessary working voltage. Further, the speed controller 40 is affixed to the handlebar of the bicycle 10 and electrically connected to the rechargeable battery pack 30 and the external rotor motor 29 for controlling the speed of the external rotor motor 29.

Thus, the bicycle 10 is practical for use by a salary man/woman or ranger for short-distance and local area application. When the user is not going to use the power drive assistant system, the user can adjust the elevation of the rotary shaft 27 relative to the clamp 21 to lift the motor 29 away from the rear wheel of the bicycle 10.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A power drive assistant system installed in a bicycle to assist running, the power drive assistant system comprising a wheel mover affixed to the seat tube of the bicycle and adapted for rotating the rear wheel of the bicycle, a rechargeable battery pack fixedly mounted on the seat pillar of the saddle of the bicycle to provide said wheel mover with the necessary working voltage, and a speed controller installed in the handlebar of the bicycle for controlling the operation speed of said wheel mover, wherein said wheel mover comprises:
a motor holder;
a motor mounted in said motor holder and movable with said motor holder into friction contact with the rear wheel of the bicycle and rotatable to move the rear wheel of the bicycle by means of a friction force;
a rotary shaft rotatably coupled to said motor holder;
a spring member sleeved onto said rotary shaft and stopped against a front side of said motor holder;
an adjustment nut threaded onto said rotary shaft and stopped against one end of said spring member opposite to said motor holder;
a lock nut threaded onto said rotary shaft and stopped at a rear side of said motor holder and adapted for locking said rotary shaft to said motor holder; and
a clamp coupled to one end of said rotary shaft adjacent to said adjustment nut for securing said rotary shaft to the seat tube of the bicycle, said clamp comprising a fixed jaw and a movable jaw pivotally connected to said rotary shaft, a locking pin pivotally connected to the free end of said fixed jaw, and an operating handle pivotally connected to the free end of said locking pin and operable to secure the free end of said locking pin to the free end of said movable jaw and to further lock said clamp to the seat tube of the bicycle.

2. The power drive assistant system as claimed in claim 1, further comprising a clutch structure coupled between said rotary shaft and said clamp for allowing elevational adjustment of said rotary shaft relative to said clamp, said clutch structure comprising a rectangular bar transversely disposed at a rear side of said clamp, a gear fixedly mounted on said rectangular bar, two spring members mounted in said rotary shaft adjacent to said gear, two pawls respectively supported on said spring members for engaging said gear, a clutch lever pivotally connected to said rotary shaft, and a cam fixedly mounted on one end of said lever between said pawls and movable by said clutch lever to selectively force said pawls away from said gear.
